(19) United States
(12) Patent Application Publication
(10) Pub. No.: US 2003/0144392 A1
(43) Pub. Date: Jul. 31, 2003

(54) Coating solution containing silicon oil and PMAE with clearing and functional agents

(76) Inventor: Bin Takigawa, Tama-shi (JP)

Correspondence Address: ADAMS & WILKS, 31st Floor, 50 Broadway, New York, NY, 10004, US

(21) Appl. No.: 10/017,245

(22) Filed: Dec. 13, 2001

(51) Int. Cl. C08K 5/16; C08K 5/36

(52) U.S. Cl. 524/224; 524/560

(57) ABSTRACT

A coating is basically a mixture of a silicone oil, a polymethacrylic acid alkyl ester and a solvent. A clearing agent of amides is added to the mixture in an amount effective to dissolve the silicone oil and the polymethacrylic acid alkyl ester to form a clear solution. A functional agent selected from either a resin and a fatty acid alkyl ester is added to the mixture in an amount effective to impart a desired coating feature to the clear solution. The clearing agent may be a compound of the amides selected from formamide, acetamide, and formohydrazide. The functional agent may be the resin made of a rosin, which is added to impart a glossing feature to the coating. Otherwise, the functional agent may be the fatty acid alkyl ester such as a palmitic acid alkyl ester, which is added to impart a smoothing feature to the coating.

### BACKGROUND OF THE INVENTION

The present invention relates to a coating solution which has good performance as a water repellant (water proof agent) or a polishing agent for fabric products such as cloth and paper, leather products and artificial porcelain products, and which is readily produced by mixing a silicone oil and a polymethacrylic acid alkyl ester (polymethacrylicacidalkylester or polymethacrylate).

U.S. Pat. No. 5,721,301 issued to Takigawa discloses a coating solution containing silicone oil and polymethacrylate. The disclosed coating solution is made from an ingredient solute comprised of silicone oil and polymethacrylicacidalkylester, a basic solvent selected from a group consisting of terpenic oil, heptane, n-decane, tetrachloroethane, 2-butanone, 1.4 dioxane, ethoxyethanol and toluene, and a buffer solvent selected from a group consisting of methanol, aceticacidalkyl and tetrachloromethane. The buffer solvent is added to a mixture of the ingredient solute and the basic solvent so that both of the silicone oil and the polymethacrylicacidalkylester can be dissolved to form a uniform solution. The disclosure of U.S. Pat. No. 5,721,301 is incorporated to the specification by referencing thereto.

### SUMMARY OF THE INVENTION

The present invention provides a coating solution comprising a first ingredient solute comprising a silicone oil and a first solvent, a second ingredient solute comprising a polymethacrylic acid alkyl ester and a second solvent, a clearing agent comprising amides and being added to a mixture of the first and second ingredient solutes in an amount effective to dissolve the silicone oil and the polymethacrylic acid alkyl ester to form a clear solution, and a functional agent selected from the group consisting of a resin and a fatty acid alkyl ester, the functional agent being added to the mixture of the first and second ingredient solutes in an amount effective to impart a desired coating feature to the clear solution.

Preferably, the clearing agent comprises a compound of the amides selected from the group consisting of formamide, acetamide and formohydrazide. The functional agent comprises the resin made of a rosin, which is added to impart a glossing feature to the clear solution. Otherwise, the functional agent comprises the fatty acid alkyl ester composed of a palmitic acid alkyl ester, which is added to impart a smoothing feature to the clear solution. The first and second solvents comprise at least one compound selected from the group consisting of terpenic oil, heptane, 2-butane and 1,4 dioxane.

The perfect clearness of the inventive coating solution is resulted from incorporation of formamide or homolog thereof as the clearing agent into the mixed solution of silicone oil and polymethacrylic acid alkyl ester. Further, the inventive coating solution contains a rosin or a higher fatty acid alkyl ester as the “functional agent”. The inventive coating is expected to be utilized as a water-repellent of fabrics or leathers, a glossing agent, or an abrasion-resistant agent of rotating elements of machines.

According to the invention, instead of methanol taught by U.S. Pat. No. 5,721,301, formamide, acetamide or formohydrazide, which are similarly electronically dipolar compounds, is used as a clearing agent for a mixed solution of a silicone oil and a polymethacrylic acid alkyl ester (hereinafter, referred to as PMAE), which are elemental materials of the present coating. A significant difference between these amides and the conventional methanol is that the amide compounds have several times stronger clearing ability than methanol. More importantly, when treating the above clearing agents with heat, namely curing the agents, they stay in the system until the last and contribute to the stabilization of the system by combining or crosslinking with other components. The present clear solution is a very good water-repellant toward fabrics and leathers.

Further, in order to improve the physical property of the basic clear solution, the functional agent is added as the second part. The performance or efficacy of the clear coating solution is improved by the functional agent. As the second part, a typical example is a rosin, which is incorporated into the above clear solution. Rosin is an inexpensive and common glossing agent, and is well soluble into the clear coating solution. The solution in which rosin is dissolved can impart good glossing feture to the coating. The leather treated with the coating solution exhibits a good water repellency and is ductile and glossy, so that the product is expected to be used as a shoe cream for boots in a cold area.

Another example of the second part is palmitic acid alkyl ester (hereinafter, referred to as PAAE) used as the functional component or additive. The compound is a plasticizer commonly used in the art of resin. PAAE is inexpensive and easily soluble in the solution. The leather piece treated with the coating containing PAAE is less glossy than the coating containing rosin, but has smooth and flexible touches and has a considerable thermal resistance. Thus, the product is expected to be used as lubricating agents for various goods such as O-rings of rotating shafts in machinery.

Finally, those articles treated with the basic clear solution of the silicone oil and PMAE, which are a main ingredient, are naturally excellent in water resistance, abrasion resistance, lubricating ability, and thermal resistance as compared with the conventional articles. The property of the basic clear solution is further improved to expand the applicable range thereof by adding the functional agent such as a glossing agent and a smoothing agent.

### DETAILED DESCRIPTION OF THE INVENTION

The present invention will be explained in accordance with the following two parts. The first part relates to a clearing agent which is incorporated into a mixed solution of a silicone oil and a polymethacrylic acid alkyl ester to clarify the solution. The second part relates to a functional agent to be newly mixed for enhancing the performance and efficacy of the clear solution.

With respect to the first part, conventionally, a clearing agent composed of methanol is used for a mixed solution of a silicone oil and PMAE. In contrast, according to the present invention, formamide, acetamide or formohydrazide is used instead of methanol. These amides are dipolar compounds based on the electronic structures of the molecules like methanol, but it is assumed from experimental results that they have different efficiency in the function of clearing the solution. The molecular structure of these compounds is indicated below.

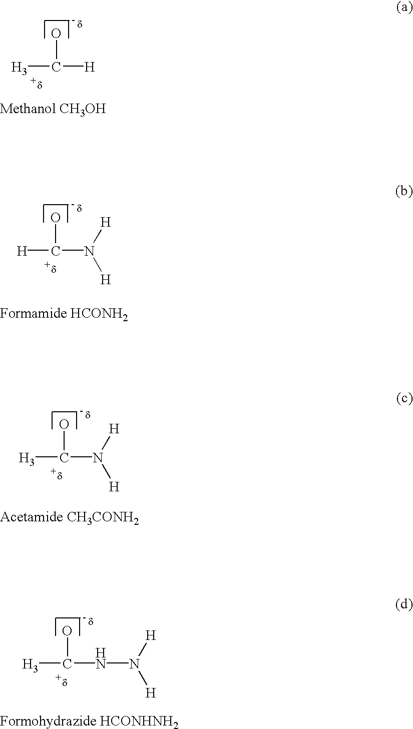

The structural formulae of electronic combination of the molecules are shown in the above. The clearing strength of the shown molecules has the following tendency due to the respective dipolar properties of the molecules.

(b)>(c)>(d)>(a)

The above tendency is determined from the necessary amount of each clearing agent to be added to the mixture.

Methanol (a) has rather poor clearing capability as compared to the amides (b), (c) and (d). Generally, the clear product is considered to be more valuable than a cloudy product or a kneaded product. The difference between these amide compounds and the methanol is explained as follows. Namely, methanol vaporizes at the treatment of a substrate with a coating and disappears from the system, but the amide compounds stay in the system. In addition, formamide is quite reactive and thus assumedly reacts with dissolved substances in the system at curing to form stable compounds, thereby contributing to stabilization of the system.

The basic clear solution obtained by adding the amides as described above exhibits the best water repellency toward fabrics and leathers. However, it is considered that the property of the basic clear solution should be improved to expand applicable field of the clear coating as the final products. Accordingly, the experiment of the second part is carried out in order to enhance the performance and efficacy of the coating. For this purpose, rosin is selected in Method A as a resin for mixing with the basic clear solution of silicone oil and PMAE. Rosin is generally used as a material for glossing, and is soluble in the solution, inexpensive, and easily available. The coating A wherein rosin is used imparts water resistance to fabric and leathers and particularly to the surface of leathers. The coating A imparts gloss and relative flexibility after application, so that it is expected to be used as a glazing agent for boots used in winter.

Next, in Method B, a palmitic acid alkyl ester is selected as the functional agent. This compound is generally used as a plasticizer, and is easily soluble in the basic clear solution, inexpensive, and easily available. The fabrics or leathers treated with the coating B obtainable by dissolving an appropriate amount of the compound palmitic acid alkyl ester in the above clear solution has, of course, a good water resistance. The leathers may show weak gloss as compared to the coating A, but the leathers treated by the coating B are smooth and flexible touches and exhibit considerable heat resistance, so that it is expected that the Coating B may be applied to O-rings and the like (bearings) of rotating shafts frequently used in machines. The practical compositions of the clear coating solution will be apparent from the following examples.

### EXAMPLES

| | | | |
|---|---|---|---|
| (a) | Silicone oil | 2 | g |
| | Heptane | 20 | cc |
| | PMAE | 2 | g |
| | 2-Butanone | 25 | cc |
| | Methanol | 3 | cc |

This solution is clear, which is comparative example wherein methanol is used as a clearing agent. Heptane is used as solvent of silicone oil, and 2-Butanone is used as solvent of PMAE.

| | | | |
|---|---|---|---|
| (b) | Silicone oil | 3 | g |
| | Terpenic oil | 30 | cc |
| | PMAE | 2 | g |
| | 1,4-Dioxane | 25 | cc |
| | Formamide | 0.3 | g |

This solution is clear, wherein formamide is used as a clearing agent. Terpenic oil is used as solvent of silicone oil, and 1,4-Dioxane is used as solvent of PMAE.

| | | | |
|---|---|---|---|
| (c) | Silicone oil | 3 | g |
| | Terpenic oil | 30 | cc |
| | PMAE | 2 | g |
| | 2-Butanone | 25 | cc |
| | Acetamide | 0.5 | g |

This solution is clear, wherein acetamide is used as a clearing agent. Terpenic oil is used as solvent of silicone oil, and 2-Butanone is used as solvent of PMAE.

| | | | |
|---|---|---|---|
| (d) | Silicone oil | 3 | g |
| | Terpenic oil | 30 | cc |
| | PMAE | 2 | g |
| | 2-Butanone | 25 | cc |
| | Formohydrazide | 0.5 | g |

This solution is clear, wherein formohydrazide is used as a clearing agent. Terpenic oil is used as solvent of silicone oil, and 2-Butanone is used as solvent of PMAE.

The above experimental examples (b), (c) and (d) relate to the present invention, and formamide, acetamide, and formohydrazide are used respectively as clearing agents instead of methanol. The difference of these amide compounds from methanol is that the amount to be added is from one fifth to one sixth of methanol as shown in each example. All these compounds are dipolar compounds in their nature of electronic structures of the molecules, but they are different in the clearing strength, the order of the strength being (b)>(c)>(d)>(a) as described above. By the way, a significant difference between these amide compounds and methanol is that the amide compounds stay in the system at the time of treating substrates and curing, and combine to other dissolved components to form stable composition. Thus, the amide compounds are considered to contribute to stabilization of the system.

The clear solution thus obtained has good properties for imparting water resistance toward fabrics and leathers. However, the basic solutions are considered to have a relatively limited range of efficacy. Thus, some experiments were carried out in order to obtain coatings having a novel performance or efficacy by mixing these solutions with a second compound. Among them, expectable examples are shown below.

| | | | |
|---|---|---|---|
| (e) | Silicone oil | 3 | g |
| | Terpenic oil | 30 | cc |
| | PMAE | 2 | g |
| | 1,4-Dioxane | 20 | cc |
| | Formamide | 0.3 | g |
| | Rosin | 3 | g |

This coating is a clear solution. The leather piece treated with the solution exhibits a good water resistance. The leather surface is glossy and ductile when touched, so that it is expected that the coating may be used as a shoe cream for boots in a cold area.

| | | | |
|---|---|---|---|
| (f) | Silicone oil | 3 | g |
| | Terpenic oil | 30 | cc |
| | PMAE | 2 | g |
| | 1,4-Dioxane | 20 | cc |
| | Formamide | 0.3 | g |
| | PAAE | 3 | g |

This coating is a clear solution. The leather piece treated with this solution is less glossy than the above example (e), but exhibits good smoothness, flexibility and bending ability when touched, and also has considerable heat resistance, so that it is expected to be used on O-rings (bearings) for rotating shafts in machinery.

The following describes the test methods for evaluating the properties of the clear coating solution.

(a) Test for water resistance

A leather piece (0.2×2.0×5.0 cm) is immersed in the coating solution, and it is immediately pulled out and placed on a watch glass on water bath, followed by drying for about 30 minutes and standing at room temperature for 10 minutes. Then, the leather piece is placed on the surface of water in a beaker and the number of days during which the piece has floated is counted so as to determine the water resistance of the coatings. The test shows the good water resistance of the inventive coating product.

(b) With regard to glaze or gloss feature, one side (smooth surface) of the above test piece (beaker) is observed. The test shows the particularly good gloss of the example (e).

(c) The ductility or flexibility is measured in a physical sense when the above piece is directly touched. The test shows the good flexibility of the example (f).

What is claimed is:

1. A coating solution comprising:
a first ingredient solute comprising a silicone oil and a first solvent;
a second ingredient solute comprising a polymethacrylic acid alkyl ester and a second solvent;
a clearing agent comprising amides and being added to a mixture of the first and second ingredient solutes in an amount effective to dissolve the silicone oil and the polymethacrylic acid alkyl ester to form a clear solution; and
a functional agent selected from the group consisting of a resin and a fatty acid alkyl ester, the functional agent being added to the mixture of the first and second ingredient solutes in an amount effective to impart a desired coating feature to the clear solution.

2. A coating solution according to claim 1; wherein the clearing agent comprises a compound of the amides selected from the group consisting of formamide, acetamide, and formohydrazide.

3. A coating solution according to claim 1; wherein the functional agent comprises the resin made of a rosin, which is added to impart a glossing feature to the clear solution.

4. A coating solution according to claim 1; wherein the functional agent comprises the fatty acid alkyl ester composed of a palmitic acid alkyl ester, which is added to impart a smoothing feature to the clear solution.

5. A coating solution according to claim 1; wherein the first and second solvents comprise at least one compound selected from the group consisting of terpenic oil, heptane, 2-butanone and 1,4 dioxane.

6. A method of producing a coating solution for coating a material, comprising the steps of:
producing a first ingredient solute comprising a silicone oil and a first solvent;
producing a second ingredient solute comprising a polymethacrylic acid alkyl ester and a second solvent;
adding a clearing agent comprising amides to a mixture of the first and second ingredient solutes in an amount effective to dissolve the silicone oil and the polymethacrylic acid alkyl ester to form a clear solution; and
adding a functional agent selected from the group consisting of a resin and a fatty acid alkyl ester, to the mixture of the first and second ingredient solutes in an amount effective to impart a desired coating feature to the clear solution.

7. A method according to claim 6; wherein the clearing agent comprises a compound of the amides selected from the group consisting of formamide, acetamide, and formohydrazide.

8. A method according to claim 6; wherein the functional agent comprises the resin made of a rosin, which is added to impart a glossing feature to the clear solution.

9. A method according to claim 6; wherein the functional agent comprises the fatty acid alkyl ester composed of a palmitic acid alkyl ester, which is added to impart a smoothing feature to the clear solution.

10. A method according to claim 6; wherein the first and second solvents comprise at least one compound selected from the group consisting of terpenic oil, heptane, 2-butanone and 1,4 dioxane.
